(19) United States
(12) Patent Application Publication
(10) Pub. No.: US 2026/0220465 A1
(43) Pub. Date: Jul. 30, 2026

(54) Method And Apparatus For Modifying Operator Through Channel Axis Tracking In Artificial Intelligence Model

(71) Applicant: NOTA, INC., Daejeon (KR)

(72) Inventors: Kyunghwan SHIM, Daejeon (KR); Shinkook CHOI, Daejeon (KR)

(73) Assignee: NOTA, INC., Daejeon (KR)

(21) Appl. No.: 19/342,113

(22) Filed: Sep. 26, 2025

(30) Foreign Application Priority Data
Jan. 24, 2025 (KR) 10-2025-0011825
Jan. 24, 2025 (KR) 10-2025-0011968
Feb. 26, 2025 (KR) 10-2025-0025384
Jun. 13, 2025 (KR) 10-2025-0077806

(51) Int. Cl. G06N 3/082; G06N 3/0499

(52) U.S. Cl. CPC G06N 3/082; G06N 3/0499

(57) ABSTRACT

The method for modifying operators by tracking a channel axis of an artificial intelligence model may comprise: receiving a first artificial intelligence model executable in a first framework; tracking, based on a forward-direction operation flow from a first reference operator to a second reference operator included in the first artificial intelligence model, a first forward candidate channel axis for each of intermediate tensors corresponding to a first intermediate operator; tracking, based on a backward-direction operation flow from the second reference operator to the first reference operator, a first backward candidate channel axis for each of the intermediate tensors; determining, based on the first forward candidate channel axis and the first backward candidate channel axis, a first channel axis for each of the intermediate tensors; and modifying, based on the determined first channel axis, at least some operators including the first intermediate operator within the first artificial intelligence model.

### CROSS-REFERENCE TO RELATED APPLICATIONS

This application claims priority to and the benefit of Korean Patent Application No. 10-2025-0077806 filed in the Korean Intellectual Property Office on June 13, 2025, the entire contents of which are incorporated herein by reference.

### TECHNICAL FIELD

The present disclosure relates to channel axis tracking technology for artificial intelligence models, and more particularly, to method and apparatus for modifying operator through channel axis tracking in artificial intelligence model.

### BACKGROUND ART

Data input and output in an operation of an artificial intelligence model is usually expressed in a form of a multi-dimensional tensor, and each dimension of the tensor has a specific meaning. In general, in the case of visual data such as an image or a video, a tensor corresponding thereto is composed of axes such as a batch, a channel, and a space. Among them, the channel includes features for expressing input and output data such as a color (e.g., RGB), a feature map, a depth, and a filter output, that is, channel information. A channel axis is an axis representing such channel information, and plays an important role in information transfer between layers of the model and a model operation.

### SUMMARY OF THE INVENTION

The present disclosure has been made to provide a method and apparatus for modifying an operator through channel-axis tracking of an artificial intelligence model.

Technical objects of the present disclosure are not restricted to the technical object mentioned as above. Other unmentioned technical objects will be apparently appreciated by those skilled in the art by referencing the following description.

According to one aspect of the present disclosure for achieving the above-described object, a method for modifying operators by tracking a channel axis of an artificial intelligence model, performed by a computing device is disclosed. The method may comprise: receiving a first artificial intelligence model executable in a first framework; tracking, based on a forward-direction operation flow from a first reference operator to a second reference operator included in the first artificial intelligence model, a first forward candidate channel axis for each of intermediate tensors corresponding to a first intermediate operator present between the first reference operator and the second reference operator; tracking, based on a backward-direction operation flow from the second reference operator to the first reference operator, a first backward candidate channel axis for each of the intermediate tensors corresponding to the first intermediate operator; determining, based on the first forward candidate channel axis and the first backward candidate channel axis, a first channel axis for each of the intermediate tensors corresponding to the first intermediate operator; and modifying, based on the determined first channel axis, at least some operators including the first intermediate operator within the first artificial intelligence model.

In one embodiment, the position of the channel axis of input and output tensors corresponding to each of the first reference operator and the second reference operator may be preset based on the first framework.

In one embodiment, the intermediate tensors may include: an intermediate input tensor input to the first intermediate operator; and an intermediate output tensor output from the first intermediate operator.

In one embodiment, the determining the first channel axis may comprise: identifying, in the first intermediate operator, a first candidate channel axis that overlaps between the first forward candidate channel axis and the first backward candidate channel axis of each of the intermediate tensors; and determining the overlapping first candidate channel axis as the first channel axis for each of the intermediate tensors corresponding to the first intermediate operator.

In one embodiment, each of the first reference operator and the second reference operator may be an operator in which the position of the channel axis of input and output tensors is identifiable without using another operator.

In one embodiment, the tracking the first forward candidate channel axis may comprise, when an operation is performed in the first intermediate operator, if the first forward candidate channel axis of an intermediate input tensor is decomposed into a plurality of axes in an intermediate output tensor, determining each of the plurality of axes as the first forward candidate channel axis of the intermediate output tensor output from the first intermediate operator.

In one embodiment, the tracking the first backward candidate channel axis may comprise, when an operation is performed in the first intermediate operator, if the first backward candidate channel axis of an intermediate output tensor is decomposed into a plurality of axes in an intermediate input tensor, determining each of the plurality of axes as the first backward candidate channel axis of the intermediate input tensor input to the first intermediate operator.

In one embodiment, the modifying at least some operators may comprise, replacing a target operator combination corresponding to at least some operators with a mathematically interchangeable substitute operator combination.

In one embodiment, in a case where a first intermediate output tensor is output from at least one first intermediate input tensor according to an operation flow of the target operator combination, the substitute operator combination may include a plurality of substitute operators having a connection relationship and properties set to output the first intermediate output tensor from the at least one first intermediate input tensor and to preserve channel information corresponding to the channel axis determined in the operation flow of the target operator combination.

In one embodiment, the target operator combination may include: a first linear transformation operator that performs a linear transformation-based operation; and a first shape transformation operator that transforms a shape of an input tensor.

In one embodiment, the substitute operator combination may include a second linear transformation operator mapped to be mathematically interchangeable with the first linear transformation operator, and the position of the channel axis included in each of the intermediate tensors of the first linear transformation operator and the position of the channel axis included in each of the intermediate tensors of the second linear transformation operator are different from each other, and the channel information corresponding to the first linear transformation operator is preserved in the second linear transformation operator.

In one embodiment, the replacing the target operator combination with the substitute operator combination may comprise, by deleting at least one first shape transformation operator included in the target operator combination, transforming the shape of each of the intermediate tensors of the first linear transformation operator to the shape of each of the intermediate tensors of the second linear transformation operator, and aligning the position of the channel axis included in each of the intermediate tensors of the first linear transformation operator to the position of the channel axis included in each of the intermediate tensors of the second linear transformation operator.

In one embodiment, the substitute operator combination may include at least one second shape transformation operator not included in the target operator combination, and the replacing the target operator combination with the substitute operator combination comprises, by adding the at least one second shape transformation operator to the target operator combination, transforming the shape of each of the intermediate tensors of the first linear transformation operator to the shape of each of the intermediate tensors of the second linear transformation operator, and aligning the position of the channel axis included in each of the intermediate tensors of the first linear transformation operator to the position of the channel axis included in each of the intermediate tensors of the second linear transformation operator.

In one embodiment, the substitute operator combination may have a smaller amount of computation than the target operator combination.

In one embodiment, at least some operators may correspond to an operation flow that is not supported by a target hardware or a target compiler, and be modified into an operation flow that is supported by the target hardware or the target compiler.

In one embodiment, the method may further comprise: tracking, based on the forward-direction operation flow from a second reference operator to a third reference operator included in the first artificial intelligence model, a second forward candidate channel axis for each of the intermediate tensors corresponding to a second intermediate operator present between the second reference operator and the third reference operator; tracking, based on the backward-direction operation flow from the third reference operator to the second reference operator, a second backward candidate channel axis for each of the intermediate tensors corresponding to the second intermediate operator; determining, based on the second forward candidate channel axis and the second backward candidate channel axis, a second channel axis for each of the intermediate tensors corresponding to the second intermediate operator; and modifying, based on the determined second channel axis, at least some operators including the second intermediate operator within the first artificial intelligence model.

In one embodiment, the method may further comprise: pruning, based on the determined first channel axis, at least one channel of the intermediate input tensor or the intermediate output tensor corresponding to the first intermediate operator.

In one embodiment, the modifying at least some operators may comprise converting the first artificial intelligence model into a second artificial intelligence model executable in a second framework, by replacing at least some operators with substitute operators executable in a second framework, based on the determined first channel axis, and the position of the channel axis included in each of the intermediate tensors of each of at least some operators may be aligned to a preset position of the channel axis in the second framework for each of the substitute operators, and the channel information corresponding to the channel axis determined in the operation flow of at least some operators may be preserved in the channel axis in the operation flow of the substitute operators.

According to one aspect of the present disclosure, a computing device for modifying operators by tracking a channel axis of an artificial intelligence model is disclosed. The computing device may comprise a processor including at least one core, wherein the processor may be configured to: receive a first artificial intelligence model executable in a first framework; track, based on a forward-direction operation flow from a first reference operator to a second reference operator included in the first artificial intelligence model, a first forward candidate channel axis for each of intermediate tensors corresponding to a first intermediate operator present between the first reference operator and the second reference operator; track, based on a backward-direction operation flow from the second reference operator to the first reference operator, a first backward candidate channel axis for each of the intermediate tensors corresponding to the first intermediate operator; determine, based on the first forward candidate channel axis and the first backward candidate channel axis, a first channel axis for each of the intermediate tensors corresponding to the first intermediate operator; and modify, based on the determined first channel axis, at least some operators including the first intermediate operator within the first artificial intelligence model.

According to one aspect of the present disclosure, a non-transitory computer readable storage medium including a computer program is disclosed. the computer program may cause a processor of a computer device to perform a method for modifying operators by tracking a channel axis of an artificial intelligence model, the method comprising: receiving a first artificial intelligence model executable in a first framework; tracking, based on a forward-direction operation flow from a first reference operator to a second reference operator included in the first artificial intelligence model, a first forward candidate channel axis for each of intermediate tensors corresponding to a first intermediate operator present between the first reference operator and the second reference operator; tracking, based on a backward-direction operation flow from the second reference operator to the first reference operator, a first backward candidate channel axis for each of the intermediate tensors corresponding to the first intermediate operator; determining, based on the first forward candidate channel axis and the first backward candidate channel axis, a first channel axis for each of the intermediate tensors corresponding to the first intermediate operator; and modifying, based on the determined first channel axis, at least some operators including the first intermediate operator within the first artificial intelligence model.

According to some embodiments of the present disclosure, it is possible to provide a method and an apparatus for modifying an operator through channel axis tracking in an artificial intelligence model. For example, through the present disclosure, it is possible to achieve more accurate channel axis tracking by tracking bidirectional operation flows of the artificial intelligence model.

Effects which can be acquired in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following embodiments, for purposes of explanation, numerous specific detailed matters are presented to provide a comprehensive understanding of one or more aspects. However, it will be apparent that the aspect(s) can be executed without the specific detailed matters. In other examples, known structures and apparatuses are illustrated in a block diagram form in order to facilitate description of one or more aspects.

FIG. 1 is a block diagram of a computing device for modifying an operator through channel axis tracking in an artificial intelligence model according to one embodiment of the present disclosure.

FIG. 2 is a schematic diagram illustrating a network function according to one embodiment of the present disclosure.

FIG. 3 is a flowchart illustrating a method for modifying an operator through channel axis tracking in an artificial intelligence model by a computing device according to one embodiment of the present disclosure.

FIG. 4 is a flowchart illustrating a model transformation process through channel axis tracking in an artificial intelligence model according to one embodiment of the present disclosure.

FIG. 5 is a diagram illustrating a process of bidirectionally tracking and determining a channel axis of the artificial intelligence model by the computing device according to one embodiment of the present disclosure.

FIG. 6 is a diagram illustrating a process of replacing a substitute target operator of the artificial intelligence model with a substitute operator by the computing device according to one embodiment of the present disclosure.

FIG. 7 is a simple and normal schematic diagram of an exemplary computing environment in which the exemplary embodiments of the present disclosure may be implemented.

### DETAILED DESCRIPTION

Various exemplary embodiments will now be described with reference to drawings. In this specification, various descriptions are presented to provide appreciation of the present disclosure. However, it will be apparent that these embodiments may be implemented without the specific descriptions set forth herein.

"Component", "module", and "system" which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, an application executed on a computing device, as well as the computing device itself, may constitute components. One or more components may reside within the processor and/or a thread of execution.

The component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “or” and “and/or” used in this specification designates and includes all available combinations of one or more items among enumerated related items.

Further, it should be appreciated that the term "comprise / include" and/or "comprising / including" means presence of corresponding features and/or components. However, it should be appreciated that the term "comprises / includes" and/or "comprising / including" means that presence or addition of one or more other features, components, and/or a group thereof is not excluded. Further, when not separately specified or it is not clear in terms of the context that a singular form is indicated, it should be construed that the singular form generally means “one or more” in this specification and the claims.

And, the term “at least one of A or B” should be interpreted to mean “a case including only A”, “a case including only B”, and “a case in which A and B are combined”.

In the present disclosure terms represented by N-th such as first, second, or third are used for distinguishing at least one entity. For example, entities expressed as first and second may be the same as each other or different from each other.

A channel axis in the present disclosure may mean an axis including a channel used to distinguish a specific attribute, feature, or information of data processed in an artificial intelligence model, among various axes of a tensor processed in the artificial intelligence model. For example, in the case of a tensor corresponding to image data, the channel may correspond to a dimension such as a color and a depth of a feature map. For example, a grayscale image has one channel indicating a binary classification of grayscale, and a color (RGB) image has three channels corresponding to respective color attributes (Red, Green, Blue).

Taking a convolutional neural network (CNN)-based artificial intelligence model as an example, when a convolution operation is performed inside the model, input data is processed using multiple filters, and the number of channels between the input data and the output data may be changed. For example, when 64 filters are applied to RGB input image data having a size of 224 × 224 × 3, an output feature map may have a size of 224 × 224 × 64. In this case, the number of channels increases from 3 to 64, which may mean that features of the input image data having been represented by three feature maps containing color information are subdivided and represented by 64 feature maps containing high-level abstract features such as edges, textures, and parts of a specific object. That is, the number of channel may mean the type or number of features extracted from an intermediate layer in the artificial intelligence model.

Meanwhile, a position of the channel axis may be set to be different for each framework for designing the artificial intelligence model. For example, in the case of a PyTorch framework, an input tensor has a shape of (B, C, H, W) (B: batch, C: channel, H: height, W: width) according to a Channel First format, and the channel axis may also be preset as a second axis (a first axis). When the artificial intelligence model processes single image data that is not in units of batch, the input tensor may have a shape of (C, H, W), and the channel axis may be preset as the first axis. Hereinafter, for convenience of description, a case in which the input/output tensor is processed in units of batch will be described as an example. In the case of the TensorFlow framework, the input tensor has a form of (B, H, W, C) according to a Channel Last format, and the channel axis may be preset as a last axis (e.g., a fourth axis in the case of a four-dimensional tensor).

In the present disclosure, the channel axis is used by way of example for convenience of description, and may be interpreted to encompass a feature axis. The feature axis may mean an axis that includes a multidimensional feature of input/output data processed by the artificial intelligence model. The channel axis mainly disclosed in the present disclosure may be understood as an axis encompassing a feature of an input/output tensor distinguished in a CNN-based artificial intelligence model, that is, a channel. Furthermore, in the case of a transformer-based artificial intelligence model, that is, a large language model (LLM), the feature axis of the input/output data may correspond to a head axis and/or a neuron axis. When the artificial intelligence model is implemented by a multi-head attention mechanism, the head axis may mean a dimension indicating the number of attention heads branched in parallel to each other and calculated independently in the multi-head attention. The neuron axis may mean a dimension of a feature vector output from each attention head, and may be used interchangeably with a hidden dimension in meaning.

Therefore, a person skilled in the art may interpret a channel axis tracking methodology in the present disclosure by easily replacing the channel axis tracking methodology with a feature axis tracking methodology. For example, a series of processes that bidirectionally track and determine the channel axis of the artificial intelligence model, and modifying an operator based on the determined channel axis according to some embodiments in the present disclosure may be implemented by being substituted with a series of processes that bidirectionally track and determine the feature axis of the artificial Intelligence model, and modify an operator based on the determined feature axis. Hereinafter, embodiments of the present disclosure will be described using the term channel axis by way of example.

An operator in the present disclosure may refer to an operation unit that performs an operation in the artificial intelligence model. The operator may include a linear transformation operator (e.g., a convolution operator, an affine transformation operator, a matrix multiplication operator, or the like) that performs a linear transformation-based operation, a shape transformation operator (for example, a reshape, transpose, squeeze, unsqueeze, flatten, expand, permute operator, or the like) that transforms a shape of an input tensor, and a non-linear transformation operator (such as a normalization operator or an activation operator) that performs a non-linear transformation-based operation. The linear transformation operator may include a projection layer that is a layer that projects the input tensor to a specific dimension. In the present disclosure, the operator may be used as a concept that encompasses a layer that is a stepwise operation unit including one or more operators.

A reference operator in the present disclosure may correspond to an operator serving as a reference for tracking a position of a channel axis of input/output tensors of each of operators included in the artificial intelligence model. A position of the channel axis of the input/output tensor corresponding to the reference operator may be preset. The computing device 100 may determine, based on a position of a channel axis of an input/output tensor of each of two reference operators, positions of channel axes of intermediate tensors of intermediate operators by bidirectionally tracking the channel axes of the intermediate tensors connected between reference operators. That is, the computing device 100 may accurately identify the position of the channel axis on the input/output tensor only with a single reference operator. The reference operator may include a linear transformation operator that performs a linear transformation-based operation such as a convolution operation or an affine transformation operation.

The reference operator in the present disclosure may refer to an operator that may clearly identify the position of a channel axis using only a single operator. The position of the channel axis of the input/output tensor in the reference operator may be previously allocated. The reference operator may refer to an operator capable of identifying the position of the channel axis of the input/output tensor without using another operator. For example, in a convolution operation that processes four-dimensional input tensors (B, C, H, W) of PyTorch, the channel axis may be pre-determined as a C axis. For a Fully Connected operator or a Linear operator, the last axis of the input tensor may be used as the channel axis. As a non-limiting example, it may be difficult to clearly track the channel axis for an operator that multiplies two variable inputs. For example, for a self-attention operator that multiplies Query and Key to create an attention map, the channel axis of Query may be determined as a last axis (−1), and in a transposed tensor of Key, the channel axis may be determined as a second axis (−2) from the last axis. When these channel axes are multiplied by each other, the corresponding channel axes may disappear.

In one embodiment, the position of the channel axis of the input/output tensor corresponding to the reference operator may be preset based on a framework. For example, in the case of a PyTorch framework, according to the Channel First format, the channel axis of the input/output tensor of the convolution operator may be preset as the second axis. In the case of a TensorFlow framework, according to the Channel Last format, the channel axis of the input/output tensor of the convolution operator may be preset as the last axis. For example, for an affine transformation operator (e.g., fully-connected layer, nn.Linear of PyTorch, Dense of TensorFlow, Gemm of ONNX, or the like), the channel axis of the input/output tensor may be preset as the last axis.

In the present disclosure, the expression of modifying an operator may include adding an operator in a connection relationship between operators, deleting some operators, and/or replacing with another operator. For example, modifying a first substitute target operator and a second substitute target operator included in the existing artificial intelligence model may include adding an additional operator in the connection relationship between the first substitute target operator and the second substitute target operator. As another example, modifying the first substitute target operator included in the existing artificial intelligence model may include deleting the first substitute target operator in the artificial intelligence model. As still another example, modifying the first substitute target operator included in the existing artificial intelligence model may include replacing with a first substitute operator to be used instead of the first substitute target operator. Meanwhile, when some substitute target operators in the artificial intelligence model are replaced, a relationship between the number of substitute target operators and the number of substitute operators may have a relationship of N : M (N and M are natural numbers).

The tensor in the present disclosure as a multi-dimensional arrangement having an arbitrary dimension may mean data input/output in the operation in the artificial intelligence model. For example, the tensor may be referred to as a scalar in the case of 0 dimension, a vector in the case of 1 dimension, a matrix in the case of 2 dimensions, or the like according to the number of dimensions. Each dimension of the tensor may correspond to a specific attribute. For example, image data may correspond to a 3-dimensional tensor having a channel, a height, and a width (C, H, W) as dimensions. When the image data is processed in units of placement on the artificial intelligence model, the image data may correspond to a 4-dimensional tensor having a batch, a channel, a height, and a width (B, C, H, W) as dimensions. In this case, an attribute included in each dimension may have a different position of the dimension according to a framework.

The input/output tensor in the present disclosure may include an input tensor input to the artificial intelligence model and/or the operator and an output tensor output from the artificial intelligence model or the operator. In this case, an input/output tensor corresponding to the intermediate operator may be used interchangeably with an intermediate tensor, corresponding to the intermediate operator, in meaning. The intermediate tensor may refer to a tensor that is input/output according to an intermediate operation flow of the artificial intelligence model, excluding an input tensor that is initially input to the artificial intelligence model and an output tensor that is finally output from the artificial intelligence model. For example, each of intermediate operators other than an initial operator or a final operator in the artificial intelligence model may input/output the intermediate tensor. The intermediate tensor may include an intermediate input tensor which is input to the intermediate operator and an intermediate output tensor which may be output from the intermediate operator. As an example in which a first intermediate operator and a second intermediate operator are connected, an intermediate output tensor output from the first intermediate operator may correspond to an intermediate input tensor of the second intermediate operator.

The framework in the present disclosure may refer to a software environment or a library set that supports learning, inference, and/or distribution of the artificial intelligence model. The framework may be configured to define and execute a structure and an operation of the artificial intelligence model. For example, PyTorch, TensorFlow, and ONNX are representative frameworks, and structures of operators and processing schemes of operators are different from one another. For example, the PyTorch is capable of performing a real-time operator operation based on a dynamic computation graph, and the TensorFlow has a structure of performing operator optimization through a static computation graph. The ONNX supports operator commonization and migration by providing an intermediate representation for compatibility between frameworks.

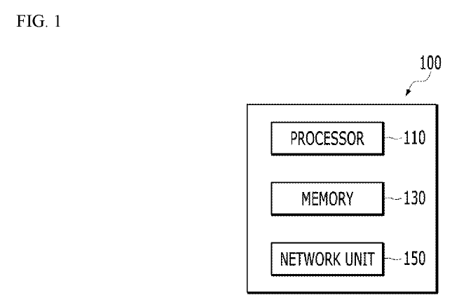

FIG. 1 is a block diagram of a computing device for modifying an operator through channel axis tracking in an artificial intelligence model according to one embodiment of the present disclosure.

A configuration of the computing device 100 illustrated in FIG. 1 is only an example illustrated through simplification. In one embodiment of the present disclosure, the computing device 100 may include other components for performing a computing configuration of the computing device 100 and only some of the disclosed components may constitute the computing device 100.

The computing device 100, according to some embodiments of the present disclosure, may be a device for modifying an operator through channel axis tracking of an artificial intelligence model. The computing device 100 may include any type of server and/or any type of device. The server may include, for example, any type of computer system or computer device, such as a microprocessor, mainframe computer, digital processor, portable device, device controller, web server, application server, or database server.

In one embodiment, the computing device 100 may include a user device. For example, the computing device 100 may correspond to a user device that receives data resources generated by any server and performs additional information processing. The user device may include, but is not limited to, a personal computer, notebook, mobile terminal, smart phone, tablet PC, or other device owned by the user.

The computing device 100 may include a processor 110, a memory 130, and a network unit 150.

The processor 110 may be composed of one or more cores and may include a processor for performing operations related to data processing, such as a central processing unit (CPU), a general-purpose graphics processing unit (GPGPU), a digital signal processor (DSP), a tensor processing unit (TPU), or a neural processing unit (NPU). The processor 110 may perform data processing for modifying an operator through channel axis tracking of an artificial intelligence model according to one embodiment of the present disclosure, by reading a computer program stored in the memory 130. In other words, a computer program stored in a computer-readable storage medium (e.g., the memory 130) may cause one or more processors (e.g., the processor 110) to perform operations for modifying an operator through channel axis tracking of an AI model, in accordance with one embodiment of the present disclosure. In addition, the processor 110 may implement any component for performing data processing to modify an operator through channel axis tracking of an AI model, according to one embodiment of the present disclosure.

According to one embodiment of the present disclosure, the processor 110 may also perform a computation for learning a neural network. For example, the processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, DSP, TPU, and NPU of the processor 110 may process learning of a network function. For example, both the CPU and the GPGPU may process the learning of the network function and data classification using the network function. Further, in one embodiment of the present disclosure, processors of the plurality of computing devices may be used together to process the learning of the network function and the data classification using the network function.

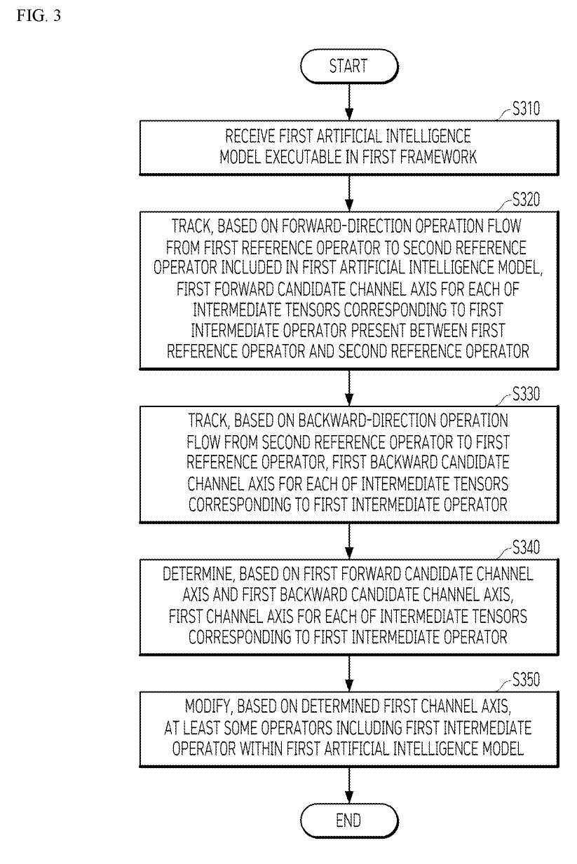

The processor 110 may generally control the overall operation of the computing device 100. For example, the processor 110 may perform the steps included in the flowchart of FIG. 3, which will be described below. By processing signals, data, or information that are input or output through the components included in the computing device 100 or by driving the application program stored in the memory 130, the processor 110 may provide or process appropriate information or functions for the user.

In one embodiment, the computing device 100 may include a system on chip (SoC). For example, the computing device 100 may include one chip on which the processor 110, the memory 130, and the network unit 150 illustrated in FIG. 1 are all mounted. In this case, the SoC may further include any modules for implementing the operation of the computing device 100, such as an I/O interface, a power management IC (PMIC), a security module, etc. Meanwhile, it will be apparent to those skilled in the art that the SoC may be referred to as a processor. Therefore, it should be interpreted that, in the embodiment, operations performed by the processor 110 in the present disclosure may be performed in the SoC.

In one embodiment of the present disclosure, the memory 130 may store any type of information generated or determined by the processor 110 and/or any type of information received by the network unit 150. In one embodiment, the memory 130 may store an artificial intelligence model, a list of optimization and/or supportable operators for each framework, a list of hardware-specific optimization and/or supportable operators, operator information for each operator, channel axis tracking information in the artificial intelligence model (e.g., forward-direction channel axis tracking information, backward channel axis tracking information and overlapping channel axis tracking information), etc.

In one embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and/or an optical disk. The computing device 100 may operate in connection with a web storage performing a storing function of the memory 130 on the Internet. The memory 130 may include an embedded memory mounted inside the processor 110 and/or a memory mounted outside the processor 110 within the computing device 100. The above description of the memory is just an example and the memory 130 used in the present disclosure is not limited thereto. The memory 130 may be operated by the processor 110.

According to one embodiment of the present disclosure, the network unit 150 may implement any type of wired or wireless communication network capable of transmitting and receiving various types of data and signals. The technologies described in the present specification may be implemented not only through the networks mentioned above, but also through other types of networks.

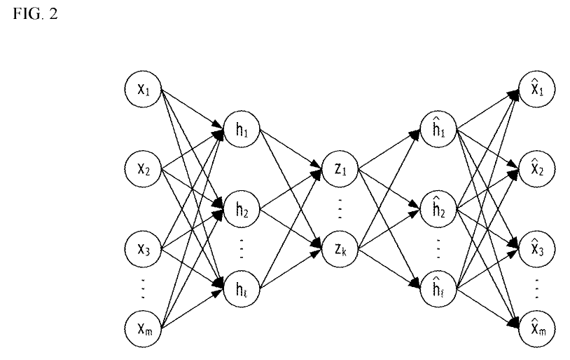

FIG. 2 illustrates a network function according to one embodiment of the present disclosure.

Throughout the present disclosure, the artificial intelligence model, the artificial intelligence based model, the operation model, and the neural network, the network function, and the neural network may be used interchangeably to refer to the same concept.

The neural network may be generally constituted by an aggregate of calculation units which are mutually connected to each other, which may be called “node”. The nodes may also be called neurons. The neural network is configured to include one or more nodes. The nodes (or neurons) constituting the neural networks may be mutually connected to each other by one or more links.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In one embodiment of the present disclosure, the set of the neurons or the nodes may be defined as the expression “layer”.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to one embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes increases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes decreases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence based model of the present disclosure may be expressed by a network structure of an arbitrary structure described above, including the input layer, the hidden layer, and the output layer.

The neural network which may be used in the artificial intelligence based model of the present disclosure may be learned in at least one scheme of supervised learning, unsupervised learning, semi supervised learning, or reinforcement learning, federated learning for distributed deep learning, and incremental learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data.

As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to one embodiment of the present disclosure, a computer-readable medium storing a data structure is disclosed. The above-described data structure may be stored in the memory 130 of the present disclosure, executed by the processor 110, and transmitted or received by the network unit 150.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node”. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

The artificial intelligence based model according to one embodiment of the present disclosure may include a large language model (LLM). The large language model in the present disclosure may mean an artificial intelligence based model trained by using a vast amount of learning data to perform natural language processing. The large language model may include the transformer, an encoder-series model of the transformer, and/or a decoder-series model of the transformer. The encoder-series model of the transformer may correspond to an artificial intelligence model using an encoder structure of the transformer. The decoder-series model of the transformer may correspond to an artificial intelligence model using a decoder structure of the transformer. For example, the artificial intelligence based model according to the present disclosure may include a GPT series large language model, a Bidirectional Encoder Representations from Transformers (BERT) series large language model, etc.

In one embodiment, the transformer may be constituted by an encoder that encodes input data and a decoder that decodes the encoded data. The transformer may have a structure which inputs a series of input data, and outputs a series of output data through encoding and decoding steps. In one embodiment, the series of input data may be processed into a form which is operable by the transformer. A process of processing the series of input data into the form which is operable by the transformer may include a tokenizing process and an embedding process. The tokenizing process may mean a process of dividing the series of input data into tokens of a predetermined unit. For example, the predetermined unit may include a word unit. The embedding process may mean a process of transforming at least one token tokenized from the series of input data into an embedding vector.

In one embodiment, the transformer may acquire an embedding vector to be input into the encoder by combining a token embedding vector which embeds at least one token corresponding to the series of input data, a segment embedding vector which segments a sentence including a token for each token, and a position embedding vector to which a position of the token is reflected. The encoder-series model and the decoder-series model of the transformer may also acquire the embedding vector by performing the same scheme.

In one embodiment, in order for the transformer to encode and decode a series of input data, the encoder and the decoder within the transformer may utilize an attention algorithm. The attention algorithm may mean an algorithm that calculates a similarity by applying a SoftMax function to an attention score acquired by a matrix multiplication of a given query and a key, and calculates an attention value for the query by performing a matrix multiplication of the calculated similarity and a value.

In one embodiment, a self-attention algorithm may mean an attention algorithm that uses the query, the key, and the value generated by multiplying the same embedding vector by each of a query weight, a key weight, and a value weight. A cross attention algorithm may mean an attention algorithm that uses a query generated by multiplying a first embedding vector by the query weight, and a key and a value generated by multiplying a second embedding vector by the key weight and the value weight, respectively. The query weight, the key weight, and the value weight may be trainable parameters which are updated through a training process of a large language model.

In one embodiment, the encoder of the transformer may include an embedding layer, a self-attention layer in which the self-attention algorithm is applied to the embedding vector, a normalization layer, and a feed forward neural network (FFN). Further, the encoder may have a form in which N unit structures including the self-attention layer, the normalization layer, and the feed forward neural network (FFN) are connected. The decoder of the transformer may include the embedding layer, a masked self-attention layer, the normalization layer, a cross attention layer to which the cross attention algorithm is applied, and the feed forward neural network. Further, the decoder may have a form in which N unit structures including the masked self-attention layer, the normalization layer, the cross attention layer, and the feed forward neural network are connected. The masked self-attention layer may correspond to a layer that obtains an attention value for each of the sequences sequentially including words in a plurality of words included in the series of input data.

The transformer may also include additional components such as a linear layer, a SoftMax layer, etc., in addition to the encoder and the decoder. Each of the encoder-series model of the transformer and the decoder-series model of the transformer may also include the additional components in addition to the encoder and the decoder. A method for constituting the transformer by using the attention algorithm may include a method disclosed in Vaswani et al., Attention Is All You Need, 2017 NIPS, which is incorporated herein by reference.

In one embodiment, the attention layer such as the self-attention layer, the masked self-attention layer, the cross attention layer, etc., may correspond to a multi-head attention layer including a plurality of attention layers in parallel. The multi-head attention layer matrix-concatenates attention values output from the plurality of attention layers, respectively, and matrix-multiplies the concatenated matrix by an output weight to output an output attention value. An output attention value output from the multi-head attention layer may have the same size as an attention value output from one attention layer.

In one embodiment, the transformer may be trained through a masked language model (MLM) process, a next sentence prediction (NSP) process, etc. The MLM process may mean a training process that predicts a masked word through a series of training data in which some words are masked. The NSP process may mean a training process that discriminates whether two sentences are concatenated sentences in a series of training data including any two sentences.

In one embodiment, the large language model may process various data formats including image data, audio data, video data, etc., in addition to a natural language text. In order to convert data with various data formats into a series of data that are computable, the large language model may embed the data. The large language model may process additional data expressing a relative positional relationship or phase relationship between a series of input data. Alternatively, the series of input data may be embedded by additionally reflecting vectors to the series of input data, the reflecting vectors expressing relative positional relationships or phase relationships between the input data. In one example, the relative positional relationship between a series of input data may include a word order within the natural language sentence, a relative positional relationship of respective segmented images, a temporal order of segmented audio waveforms, etc., but is not limited thereto. A process of adding information expressing a relative positional relationship or phase relationship between a series of input data may be referred to as positional encoding.

One example (Vision Transformer, ViT) of the large language model which processes image data is disclosed in Dosovitskiy, et al., An Image is Worth 16X16 Words: Transformers for Image Recognition at Scale, which is incorporated herein by reference.

The artificial intelligence model according to one embodiment of the present disclosure may include a multi-modal large language model. The multi-modal large language model may mean a large language model that may understand and process a relationship between different data formats including natural language text data, image data, audio data, video data, etc. The multi-modal language model may include a plurality of encoders which encode input data corresponding to each data format. The multi-modal language model may be trained to calculate a similarity between embedding vectors encoded from the encode, which have respective data formats through training data including data with different data formats, calculate a similarity for the same pair to be higher, and calculate a similarity for different pairs to be lower.

One example (Contrastive Language-Image Pre-training, CLIP) of the multi-modal large language model which understands and processes the relationship between the image data and the natural language text data is disclosed in Alec Radford, et al., Learning Transferable Visual Models from Natural Language Supervision, which is incorporated herein by reference.

Deep learning frameworks or operators may have different development difficulty and/or optimized specific hardware or compiler. For example, while the PyTorch framework is relatively simple to develop, its performance is not fully optimized over various hardware, and the TensorFlow framework ensures stable performance on various hardware, but presents relatively higher development difficulty as compared to PyTorch. As another example, in the case of NVIDIA, model conversion to TensorRT is recommended for model optimization in the NVIDIA GPU, and in the case of Renesas, a specific operator may be accelerated through DRP-AI. There is a very large speed difference between when such runtime is utilized and when the model is operated on a general CPU without using the runtime. In addition, in certain cases, a situation may occur in which the model does not operate at all.

On the other hand, a channel axis is an axis that must be maintained in order to create a calculation equivalence between operators, and accurate identification and tracking of the channel axis is an essential process in various artificial intelligence model optimization and conversion processes. To this end, a linear transformation operator performs a dimension transformation in a direction that maintains the corresponding axis even if the dimension increases in the output tensor. For example, in order to optimize an artificial intelligence model in target hardware (e.g., CPU, GPU, NPU, FPGA, etc.), when transforming a specific operator in the model into an operator that may be optimized to the target hardware or supportable, it is essential to accurately track the channel axis to maintain channel information. As another example, when transforming an artificial intelligence model into a target framework (e.g., PyTorch, TensorFlow, ONNX, etc.), the position of the channel axis may be defined differently in the transformation process between different frameworks, and accordingly, by accurately tracking the channel axis, it is necessary to maintain the channel information even when the position of the channel axis changes according to the operator or layout rule of the target framework. For example, when PyTorch is used for ease of development of an artificial intelligence model, but transformation to TensorFlow is required for device optimization, channel axis tracking is essential for transformation from PyTorch following the Channel First format to TensorFlow following the Channel Last format.

As a result, hereinafter, a method for modifying an operator through channel axis tracking of the artificial intelligence model by the computing device 100 according to one embodiment of the present disclosure will be disclosed. Hereinafter, operations performed by the processor 110 of the computing device 100 will be expressed as being performed by the computing device 100.

FIG. 3 is a flowchart illustrating a method for modifying an operator through channel axis tracking in an artificial intelligence model by a computing device according to one embodiment of the present disclosure. The flowchart illustrated in FIG. 3 is merely an exemplary order, and some steps may be omitted, the order may be changed, or other steps may be added within a range obvious to those skilled in the art.

In step S310, the computing device 100 according to one embodiment may receive a first artificial intelligence model executable in a first framework. For example, the first artificial intelligence model may correspond to a model developed in the first framework. The first artificial intelligence model includes a plurality of operators. When the first artificial intelligence models are executed, starting with an initial operator processing input data to output intermediate output data, each intermediate operator may process the intermediate input data according to a connection relationship and an attribute to output the intermediate output data, and a final operator may output final output data. The computing device 100 may receive the first artificial intelligence model from an external server connected wiredly or wirelessly, or may obtain the first artificial intelligence model developed based on the connection relationship and the attributes of the operators set according to a user input. Receiving the first artificial intelligence model may be used interchangeably, in meaning, with receiving a user input defining a structure of the first artificial intelligence model including the connection relationship and the attributes of the operators.

In step S320, the computing device 100 according to one embodiment may track a first forward candidate channel axis for each of intermediate tensors corresponding to the first intermediate operator present between the first reference operator and the second reference operator based on a forward-direction operation flow from the first reference operator to the second reference operator included in the first artificial intelligence model. The computing device 100 may track the forward candidate channel axis for each of the intermediate tensors respectively corresponding to the intermediate operators present between the first and second reference operators based on the forward-direction operation flow from the first reference operator to the second reference operator. In the present disclosure, tracking or determining the channel axis of the tensor by the computing device 100 may mean tracking or determining a position or an index of the channel axis in the tensor.

The forward-direction operation flow in the present disclosure may refer to an operation flow of receiving input data in the artificial intelligence model and sequentially performing operations according to respective layer, that is, respective intermediate operators, to calculate a final output value. In the first artificial intelligence model, at least one intermediate operator may exist between the first reference operator and the second reference operator. An intermediate output tensor output from the first reference operator may be input to the second reference operator through an intermediate operation process from at least one intermediate operator according to the forward-direction operation flow.

In one embodiment, a position of a channel axis of an input/output tensor corresponding to each of the first reference operator and the second reference operator may be preset with reference to the first framework. Each of the first reference operator and the second reference operator may be an operator in which position of the channel axis of the input/input tensor is identifiable without using another operator. For example, in an example in which the first reference operator or the second reference operator is a convolution operator, the position of the channel axis of the input/output tensor of the first reference operation or the second reference operation may be preset to a second axis in a case that the first framework is PyTorch, and to a last axis in the case of TensorFlow. As another example, in an example in which the first reference operator or the second reference operator is an affine transformation operator, the position, of the channel axis of the input/output tensor of the first reference operator or the second reference operator may be preset to the last axis. Meanwhile, in the case of a matrix multiplication operator or an affine transformation operator, positions and the number of channel axes in the input/output tensor may be different, and may be preset before tracking the channel axis. For example, the matrix multiplication operator (MatMul operator) or the affine transformation operator may have one or more channel axes.

In one embodiment, the intermediate tensors corresponding to the first intermediate operator may include an intermediate input tensor input to the first intermediate operator and an intermediate output tensor output from the first intermediate operator. In a case where the first intermediate operator and the second intermediate operator are connected according to the forward-direction operation flow, the intermediate output tensor output from the first intermediate operator may be input to the second intermediate operator as the intermediate input tensor of the second intermediate operator. On the contrary, in a case where a third intermediate operator and the first intermediate operator are connected according to the forward-direction operation flow, an intermediate output tensor output from the third intermediate operator may be input to the first intermediate operator as the intermediate input tensor of the first intermediate operator.

In step S330, the computing device 100 according to one embodiment may track a first backward candidate channel axis for each of the intermediate tensors corresponding to the first intermediate operator, based on a backward-direction operation flow from the second reference operator to the first reference operator. The computing device 100 may track the backward candidate channel axis for each of the intermediate tensors respectively corresponding to the intermediate operators present between the first and second reference operators based on the backward-direction operation flow from the second reference operator to the first reference operator. The backward-direction operation flow in the present disclosure may refer to an opposite direction to the forward-direction operation flow of receiving input data in the artificial intelligence model and sequentially performing operations according to respective layer, that is, respective intermediate operators, to calculate the final output value. That is, tracking the backward candidate channel axis of each of the intermediate tensors corresponding to the first intermediate operator based on the backward-direction operation flow may mean tracking the channel axis of the intermediate input tensor corresponding to the first intermediate operator from the channel axis of the intermediate output tensor corresponding to the first intermediate operator.

In one embodiment, the computing device 100 may track, based on the forward-direction operation flow, a first forward candidate channel axis of the intermediate input tensor corresponding to the first intermediate operator and a first forward candidate channel axis of the intermediate output tensor. In this case, the first forward candidate channel axis of the intermediate input tensor and the first forward candidate channel axis of the intermediate output tensor may be consistent with or different from each other. Similarly, the computing device 100 may track, based on the backward-direction operation flow, a first backward candidate channel axis of the intermediate output tensor corresponding to the first intermediate operator, and a first backward candidate channel axis of the intermediate input tensor. In this case, the first backward candidate channel axis of the intermediate output tensor and the first backward candidate channel axis of the intermediate input tensor may be consistent with or different from each other.

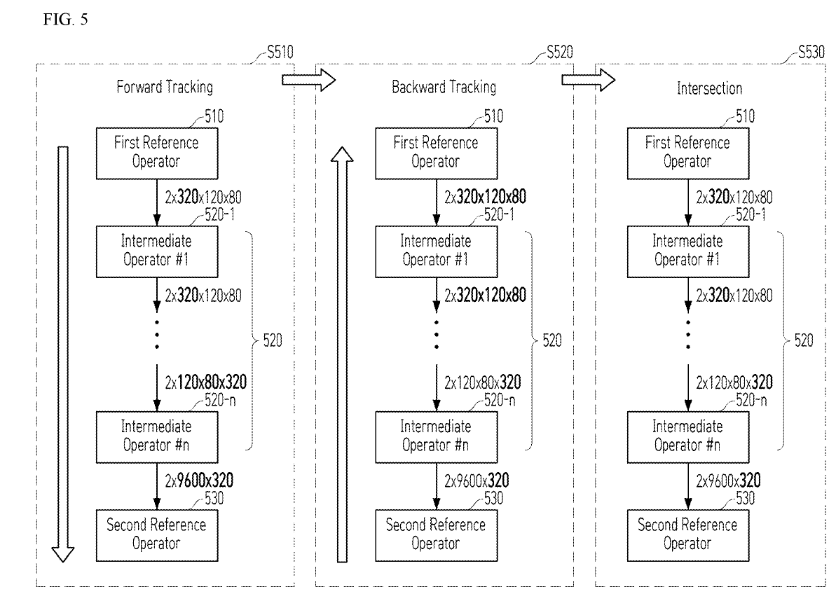

In step S340, the computing device 100 according to one embodiment may determine the first channel axis for each of the intermediate tensors corresponding to the first intermediate operator based on the first forward candidate channel axis and the first backward candidate channel axis. The computing device 100 may determine the channel axis of each of the intermediate tensors respectively corresponding to the intermediate operators present between the first reference operator and the second reference operator, based on the forward candidate channel axis and the backward candidate channel axis calculated based on the bidirectional operation flows. A method for determining the channel axis of each of the intermediary tensors corresponding to the intermediate operators, by the computing device 100 according to steps S320, S330, and S340 will be described below in detail with reference to FIG. 5.

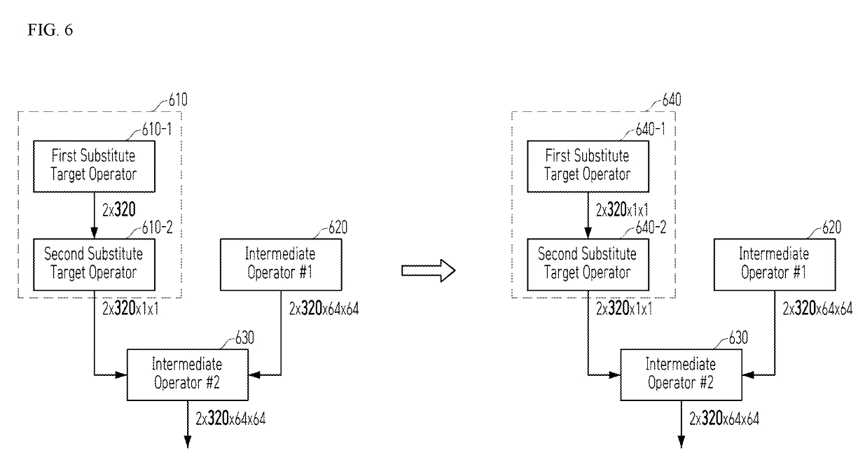

In step S350, the computing device 100 according to one embodiment may modify, based on the determined first channel axis, at least some operators including the first intermediate operator in the first artificial intelligence model. A detailed description of a methodology by which the computing device 100 replaces some operators based on the determined channel axis will be described below with reference to FIG. 6.

In one embodiment, the first reference operator and the second reference operator may include at least one branch node that generates a plurality of operation flows, that is, paths. A node may correspond to an operator on a model graph in which an artificial intelligence model is expressed in a graph form. In this case, a plurality of paths may exist between the first reference operator and the second reference operator. The computing device 100 may determine the channel axes of the intermediate tensors respectively corresponding to the intermediate operators present in the plurality of respective paths by performing the channel axis determination process based on the bidirectional operation flows of steps S320, S330, and S340 on the plurality of respective paths.

In one embodiment, the first reference operator may correspond to an initial operator that receives an input tensor input to the first artificial intelligence model. Alternatively, the second reference operator may correspond to a final operator that outputs an output tensor output from the first artificial intelligence model. When the first reference operator corresponds to the initial operator and the second reference operator corresponds to the final operator, the positions of the channel axes of the intermediate operators may be tracked and determined based on the bidirectional operation flows between the first reference operator and the second reference operator, so as to determine the positions of the channels axes of the operators in the first artificial intelligence model.

In one embodiment, when the first reference operator corresponds to the initial operator, in addition to the channel axis tracking between the first reference operator and the second reference operator, channel axis tracking for operators after the second reference operator may be additionally performed. In this case, the channel axis tracking for the operators after the second reference operator may be performed based on a position of a channel axis of an output tensor of the second reference operator and a position of the channel axis of an input tensor of the third reference operator included in the first artificial intelligence model next to the second reference operator. That is, the second reference operator is used for backward-direction channel axis tracking with respect to the first reference operator, and may be used for forward-direction channel axis tracking with respect to the third reference operator.

For example, the computing device 100 may track the second forward candidate channel axis for each of the intermediate tensors respectively corresponding to the second intermediate operators present between the second reference operator and the third reference operator based on the forward-direction operation flow from the second reference operator to the third reference operator included in the first artificial intelligence model. The computing device 100 may track the second backward candidate channel axis for each of the intermediate tensors respectively corresponding to the second intermediate operators based on the backward-direction operation flow from the third reference operator to the second reference operator. The computing device 100 may determine the second channel axis for each of the intermediate tensors corresponding to the second intermediate operator, based on the second forward candidate channel axis and the second backward candidate channel axis. The computing device 100 may modify, based on the determined second channel axis, at least some operators including the second intermediate operator within the first artificial intelligence model.

In one embodiment, when the second reference operator corresponds to the final operator, in addition to the channel axis tracking between the first reference operator and the second reference operator, channel axis tracking for operators before the first reference operator may be additionally performed. In this case, the channel axis tracking for the operators before the first reference operator may be performed based on a position of a channel axis of an output tensor of the fourth reference operator and a position of the channel axis of an input tensor of the first reference operator included in the first artificial intelligence model before the first reference operator. That is, the first reference operator is used for backward-direction channel axis tracking with respect to the fourth reference operator, and may be used for forward-direction channel axis tracking with respect to the second reference operator.

For example, the computing device 100 may track the third forward candidate channel axis of each of the intermediate tensors respectively corresponding to the third intermediate operators present between the fourth reference operator and the first reference operator based on the forward-direction operation flow from the fourth reference operator to the first reference operator included in the first artificial intelligence model. The computing device 100 may track the third backward candidate channel axis for each of the intermediate tensors respectively corresponding to the third intermediate operators based on the backward-direction operation flow from the first reference operator to the fourth reference operator. The computing device 100 may determine the third channel axis of each of the intermediate tensors corresponding to the third intermediate operator based on the third forward candidate channel axis and the third backward candidate channel axis. The computing device 100 may modify, based on the determined third channel axis, at least some operators including the third intermediate operator within the first artificial intelligence model.

Through the present disclosure, it is possible to achieve a technical effect that an operator of an artificial intelligence model can be modified to be optimized for a framework, so that a user can develop and distribute an artificial intelligence model by utilizing only advantages of various deep learning frameworks. In addition, after development of the artificial intelligence model, when a specific operator is supported or optimized in a specific hardware, device, or compiler, a technical effect that the specific operator may be converted into an operator that may be supported or optimized in the specific hardware, device or compiler based on a tracked channel axis without a model re-implementation process from a development stage may be achieved.

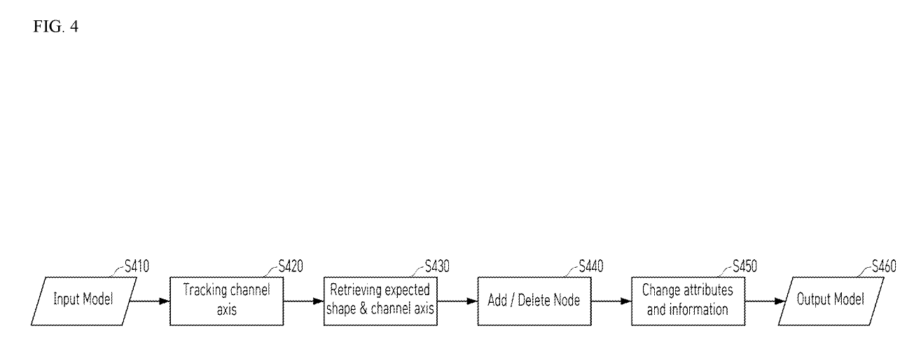

FIG. 4 is a flowchart illustrating a model transformation process through channel axis tracking in an artificial intelligence model according to one embodiment of the present disclosure.

In step S410, the computing device 100 according to one embodiment may receive a first artificial intelligence model . In this case, the computing device 110 may also receive information regarding a first framework in which the first artificial intelligence model is developed. The computing device 100 may input the first artificial intelligence model into an artificial intelligence model optimization system based on channel axis tracking. In step S420, the computing device 100 according to one embodiment may track candidate channel axes of intermediate tensors respectively corresponding to intermediate operators present between the first reference operator and the second reference operator included in the first artificial intelligence model, based on the bidirectional operation flows.

In step S430, the computing device 100 according to one embodiment may determine channel axes of the intermediate tensors corresponding to the respective intermediate operators based on the tracked forward candidate channel axes and backward candidate channel axes. In this process, the computing device 110 may track not only the channel axis but also shapes of the intermediate tensors respectively corresponding to the intermediate operators. In this case, the arrangement axis may be maintained at one position, and channel information may be maintained even when the position of the channel axis is changed according to the operation flow.

In operation S440, the computing device 100 according to one embodiment may replace a combination of substitute target operators present in the first artificial intelligence model with a combination of substitute operators to be used instead of the substitute target operator. For example, the computing device 100 may delete unnecessary or unsupportable substitute target operators and add substitute operators from or to the first artificial intelligence model.

In step S450, the computing device 100 according to one embodiment may change attributes and information of the substitute operators. For example, even after the substitute target operator combination is changed to the substitute operator combination, the computing device 100 may set attributes of respective substitute operators (e.g., a shape of an input/output tensor, a parameter, operator identification information, a position of an operator in the artificial intelligence model, and the like) so that information and a shape of a final output tensor of the substitute operator combination are not different from information and a shape of a final output tensor of the substitute target operator combination. Alternatively, after the substitute operator combination is changed, the attributes of the substitute operators may be set and attributes of intermediate maintenance operators maintained in addition to the substitute operator may be changed so that the information and the shape of the final output tensor of the first artificial intelligence model are not changed. The computing device 100 may set attributes of the substitute operators and/or the intermediate maintenance operators for each version based on operator information for each version.

For example, when the substitute operator combination includes a reshape operator and an output tensor of the reshape operator needs to have a specific form (e.g., 2 × 32 × 1 × 40960), an attribute of the reshape operator may be set to have the specific form (e.g., a value of the attribute of the reshape operator is set to [2, 32, 1, 40960]). When the operator is replaced, a channel axis having a positive index in an intermediate tensor may be identified by being maintained as it is during conversion, and a channel axis having a negative index may be identified by converting to a positive index (e.g., an index of −1 to an index of 3 in the case of a four-dimensional tensor) for shape alignment.

In step S460, the computing device 100 according to one embodiment may output a second artificial intelligence model in which the substitute target operator combination is changed to the substitute operator combination. For example, the artificial intelligence model optimization system may output the second artificial intelligence model obtained by optimizing the first artificial intelligence model.

FIG. 5 is a diagram illustrating a process of bidirectionally tracking and determining a channel axis of the artificial intelligence model by the computing device according to one embodiment of the present disclosure. Hereinafter, a part of descriptions regarding the steps of FIG. 5, which overlaps with the descriptions regarding the step of FIG. 3, will be omitted for clarity of the disclosure.

In step S510, the computing device 100 according to one embodiment may track, based on a forward-direction operation flow from a first reference operator 510 to a second reference operator 530 included in the first artificial intelligence model, a first forward candidate channel axis of each of intermediate tensors corresponding to a first intermediate operator 520-1 present between the first reference operator 510 and the second reference operator 530. The first intermediate operator 520-1 of FIG. 5 is merely an example, and the first intermediate operator 520-1 may correspond to any of intermediate operators 520. For example, the first intermediate operator 520-1 may correspond to an intermediate operator that is not directly connected to the first reference operator 510. Further, when there is only one intermediate operator between the first reference operator 510 and the second reference operator 530, the first intermediate operator 520-1 and an Nth intermediate operator 520-n may refer to the same operator. The computing device 100 may track forward candidate channel axes of intermediate tensors respectively corresponding to the intermediate operators 520, including the Nth intermediate operator 520-n present between the first reference operator 510 and the second reference operator 530 as well as the first intermediate operator 520-1.

Referring to FIG. 5 as an example, the channel axis of the output tensor of the first reference operator 510 may be preset to be a second axis having 320 dimensions. Then, the channel axes of the intermediate output tensor of the first intermediate operator 520-1 may be tracked to be the same axis as the channel axis of the intermediate input tensor. The channel axis of the intermediate input tensor of the Nth intermediate operator 520-n may be tracked, through the operation flow of the intermediate operators, to be three axes respectively having 120 dimensions, 80 dimensions, and 320 dimensions. The channel axis of the intermediate output tensor of the Nth intermediate operator 520-n may be tracked, based on the channel axis of the intermediate input tensor, to be two axes respectively having 9600 dimensions and 320 dimensions. The channel axis of the input tensor of the second reference operator 530 may be tracked to be the same as the channel axis of the intermediate output tensor of the Nth intermediate operator 520-n.

In one embodiment, channel expansion and/or channel contraction may occur on a channel axis according to an operation process of an operator. The channel expansion may refer to a case in which channel information is decomposed into a plurality of axes and a plurality of channel axes are present, and the channel contraction may refer to that the number of a plurality of channel axis is contracted according to the operation process of the operator.

In one embodiment, if the first forward candidate channel axis of the intermediate input tensor is decomposed into a plurality of axes in the intermediate output tensor when the first intermediate operator 520-1 performs an operation, the computing device 100 may determine each of the plurality of the axes as the first forward candidate channel axis of the intermediate output tensor output from the first intermediate operator 520-1.

In step S520, the computing device 100 according to one embodiment may track, based on a backward-direction operation flow from the second reference operator 530 to the first reference operator 510 included in the first artificial intelligence model, a first backward candidate channel axis of each of intermediate tensors corresponding to the first intermediate operator 520-1. The computing device 100 may track backward candidate channel axes of intermediate tensors respectively corresponding to the intermediate operators 520, including the Nth intermediate operator 520-n present between the first reference operator 510 and the second reference operator 530 as well as the first intermediate operator 520-1.

Referring to FIG. 5 as an example, the channel axis of the input tensor of the second reference operator 530 may be preset to be a final axis having 320 dimensions. Then, the channel axes of the intermediate input tensors of the Nth intermediate operator 520-n may be tracked to be the final axis with respect to the channel axis of the intermediate output tensor. The channel axis of the intermediate output tensor of the first intermediate operator 520-1 may be tracked, through the backward-direction operation flow of the intermediate operators, to be three axes respectively having 320 dimensions, 120 dimensions, and 800 dimensions. The channel axes of the intermediate input tensors of the first intermediate operator 520-1 may be tracked to be the same three axes with respect to the channel axis of the intermediate output tensor. The channel axis of the input tensor of the first reference operator 510 may be tracked to be the same as the channel axis of the intermediate input tensor of the first intermediate operator 520-1.

In one embodiment, in tracking the first backward candidate channel axis, if the first backward candidate channel axis of the intermediate output tensor is decomposed into a plurality of axes in the intermediate input tensor when the first intermediate operator 520-1 performs an operation, the computing device 100 may determine each of the plurality of the axes as the first backward candidate channel axis of the intermediate input tensor input into the first intermediate operator. That is, when the channel contraction occurs in the first intermediate operator 520-1, the computing device 100 may determine the plurality of candidate channel axes of the intermediate output tensor that are tracked based on the first backward candidate channel axis of the intermediate output tensor as the first backward candidate channel axis of the intermediate input tensor according to the backward-direction operation flow.

In step S530, the computing device 100 according to one embodiment may determine the first channel axis of each of the intermediate tensors corresponding to the first intermediate operator based on the first forward-direction candidate channel axis and the first backward-direction candidate channel axis. For example, in determining the channel axis, the computing device 100 may identify, in the first intermediate operator 520-1, a first candidate channel axis that overlaps with each other between the first forward candidate channel axis and the first backward candidate channel axis of each of the intermediate tensors. The computing device 100 may determine the overlapping first candidate channel axis as the first channel axis for each of the intermediate tensors corresponding to the first intermediate operator 520-1. The computing device 100 may identify a candidate channel axis that overlaps between the forward candidate channel axis and the backward candidate channel axis of the intermediate tensor corresponding to each of the intermediate operators 520, and determine the identified candidate channel axis as the channel axis of the intermediate tensors corresponding respectively to the intermediate operators 520. Referring to FIG. 5 as an example, a candidate channel axis having overlapping 320 dimensions from among the forward candidate channel axis tracked in step S510 and the backward candidate channel axis tracked in step S520 may be determined as the channel axis of the intermediate tensor corresponding to each intermediate operator.

In this way, it is possible to achieve a technical effect of solving a problem that a plurality of channel axes are tracked according to the forward-direction operation flow or the backward-direction operation flow, and determining an accurate channel axis.

FIG. 6 is a diagram illustrating a process of replacing a substitute target operator of the artificial intelligence model with a substitute operator by the computing device according to one embodiment of the present disclosure.

In one embodiment, when modifying at least some operators, the computing device 100 may replace the substitute target operator combination 610 corresponding to the at least some operators with a mathematically interchangeable substitute operator combination 640. In the present disclosure, the term “substitute target operator” or “substitute target operator combination” may refer to an operator or an operator combination to be substituted. In the present disclosure, a substitute target operator may be referred to as a target operator. Similarly, a substitute target operator combination may be referred to as a target operator combination. In the present disclosure, mathematically interchangeable operators or operator combinations are operators or operators combinations that perform the same mathematical operation (e.g., linear transformation, matrix multiplication, etc.), and may mean two operators or two operator combinations that may generate the same output value as a result, although there may be differences in the form transformation or internal implementation of the input and weight. For example, both the General Matrix Multiplication (GEMM) operator of the ONNX framework and the nn.Linear operator of PyTorch perform affine transformation operations that perform matrix multiplication with a weight matrix and add bias to the input tensor, and thus may correspond to mathematically interchangeable operators.

For example, the substitution target operator combination 610 may be grouped, based on the determined first channel axis, from among a first reference operator, a second reference operator, and a plurality of intermediate operators present between the first reference operator and the second reference operator in the first artificial intelligence model. For example, the substitute target operator combination 610 includes a first linear transformation operator that performs a linear transformation-based operation and a first shape transformation operator that transforms a shape of an input tensor. In addition, the substitution target operator combination 610 may include a first nonlinear transformation operator that performs the nonlinear transformation-based operation. The first intermediate operator may correspond to a first substitute target operator 610-1 or a second substitute target operator 610-2.

In one embodiment, when the substitute target operator combination 610 is replaced with the substitute operator combination 640, the attribute of the remaining intermediate maintenance operators 620 and 630 that are not replaced may be changed based on the attribute of the substitute operator combination 640.

In one embodiment, in a case where the first intermediate output tensor is output from the at least one first intermediate input tensor according to the operation flow of the substitute target operator combination 610, the substitute operator combination 640 may include a plurality of substitute operators 640-1 and 640-2 having a connection relationship and properties set to output the first intermediate output tensor from the at least one first intermediate input tensor and to preserve channel information corresponding to a channel axis determined in the operation flow of the substitute target operator combination 610.

In one embodiment, the substitute operator combination 640 may include a second linear transformation operator mapped to be mathematically interchangeable with the first linear transformation operator included in the substitute target operator combination 610. In this case, a position of a channel axis included in each of the intermediate tensors of the first linear transformation operators and a position of the channel axis included in each of the intermediate tensors of the second linear transformation operator may be different from each other. Channel information corresponding to the first linear transformation operator may be preserved in the second linear transformation operator. That is, the position of the channel axis may be changed, and the channel information may be maintained in the channel axis.

In one embodiment, in replacing the substitute target operator combination 610 with the substitute operator combination 640, the computing device 100 may transform the shape of each of the intermediate tensors of the first linear transformation operator to the shape of each the intermediate tensors of the second linear transformation operator by deleting the at least one first shape transformation operator included in the substitute target operator combination 610, and align the position of the channel axis included in each of the intermediate tensors of the first linear transformation operator to the position of the channel axis included in each of the intermediate tensors of the second linear transformation operator. For example, in the case of replacing a first linear transformation operator defined in PyTorch with a second linear transformation operator defined in TensorFlow, the position of the channel axis may be aligned from the second axis to the final axis.

In one embodiment, the substitute operator combination 640 may include at least one second shape transformation operator not included in the substitute target operator combination 610. In replacing the substitute target operator combination 610 with the substitute operator combination 640, the computing device 100 may transform the shape of each of the intermediate tensors of the first linear transformation operator to the shape of each the intermediate tensor of the second linear transformation operator by adding at least one second shape transformation operator to the substitute target operator combination 610, and align the position of the channel axis included in each of the intermediate tensors of the first linear transformation operator to the position of the channel axis included in each of the intermediate tensors of the second linear transformation operator. For example, in converting the first linear transformation operator to the second linear transformation operator, a shape of the input/output tensor defined in the first linear transformation operator and a shape of the output/output tensor defined in the second linear transformation operator may be different from each other. The second shape transformation operator may correspond to an operator that converts the shape corresponding to the tensor of the first linear transformation operator into the shape corresponding to the tensor of the second linear transformation operator.

In one embodiment, the substitute operator combination 640 may have a smaller amount of computation than the substitute target operator combination 610. For example, when executed on a target hardware and/or a target compiler, the substitute operator combination 640 may have a smaller amount of computation and/or less operation time than the substitute target operator combination 610.

In one embodiment, at least some operators may correspond to an operation flow that is not supported by a target hardware or a target compiler, and may be modified into an operation flow that is supported by the target hardware or the target compiler. That is, the substitute target operator combination 610 may correspond to an operation flow that is unsupportable in the target Hardware and/or the target compiler, and the substitute operator combination 640 may correspond to an operation flow that is supportable in the targeted hardware and/ or the targeted compiler. In this case, the operation flow that is not supportable in the target hardware and/or the target compiler may include an operation flow that may not be optimized in the target hardware and/or the target compiler. Conversely, the operation flow that is supportable in the target hardware and/or the target compiler may include an operation flow that may be optimized in the target hardware and/or the target compiler.

In one embodiment, the computing device 100 may prune at least one channel of the intermediate input tensor or the intermediate output tensor corresponding to the first intermediate operator based on the determined first channel axis. For example, the computing device 100 may prune some channels of the channels of the plurality of dimensions based on the determined channel axis, based on a performance score according to a pruning technique of the first artificial intelligence model. As an example of replacing the channel axis with a feature axis, a head or a hidden dimension of a head axis or a neuron axis may be pruned based on the head axis and the neuron axis of the multi-head attention. When a part of the head axis is pruned, the pruning may be classified as head pruning, and when a part of the neuron axis is pruned, the pruning may be classified as neuron pruning.

In one embodiment, in modifying the at least some operators 610-1 and 610-2, the computing device 100 may convert the first artificial intelligence model into a second artificial intelligence model executable in the second framework by replacing the at least some operators 610-1 and 6102 with substitute operators 640-1 and 640-2 executable in a second framework, based on the determined first channel axis. For example, the computing device 100 may convert the first artificial intelligence model into a second artificial intelligence model executable on the second framework by replacing the substitute target operator combination 610 with the substitute operator combination 640 executable on the second framework. In this case, the position of the channel axis included in each of the intermediate tensors of each of the at least some operators 610-1 and 610-2 may be aligned to a preset position of the channel axis in the second framework for each of the substitute operators 640-1 and 640-2. In addition, channel information corresponding to the channel axis determined in the operation flow of the at least some operators 610-1 or 610-2 may be equally preserved in the channel axis on the operation flow of the substitute operators 640-1 or 640-2.

For example, the first substitute target operator 610-1 may correspond to a first linear transformation operator such as a Gemm operator, a MatMul operator, and a Conv (convolutional) operator, and the second substitute target operator 610-2 may correspond to a first shape transformation operator such as unsqueeze, transpose, and reshape. In this case, the computing device 100 may replace the first substitute target operator 610-1 with the mathematically interchangeable first substitute operator 640-1. Thereafter, as the computing device 100 may convert the first substitute target operator 610-1 to the first substitute operator 640-1, the computing device 100 may transform the shape of the output tensor of the first substitute operator 640-1 to a shape of an output tensor of an existing substitute target operator combination 610 and delete the second substitute target operator 610-2 and add the second substitute operator 640-2, which is a shape transformation operator, to align the channel axes. In addition, the substitute target operator combination 610 and/or the substitute operator combination 640 may include an additional shape transformation operator. For example, the computing device 100 may add an additional shape transformation operator that transforms the shape of the input tensor of the existing substitute target operator combination 610 to match the shape of the input tensor of the first substitute operator 640-1.

For example, when the first substitute target operator 610-1 is a two-dimensional Gemm operator, the first substitute target operator 610-1 may be replaced with the first substitute operator 640-1 corresponding to a four-dimensional Conv operator or a MatMul operator. In this case, unsqueeze, which is the second substitute target operator 610-2, may be deleted, and the second substitute operator 640-2 corresponding to a transpose operator for matching a shape of a final output tensor or an add operator for applying a fixed bias may be added.

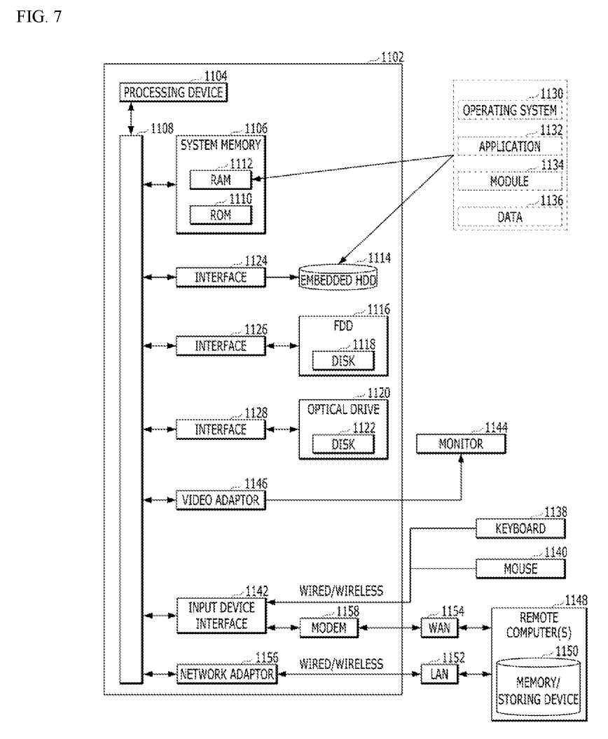

FIG. 7 is a simplified and general schematic diagram of an exemplary computing environment in which embodiments of the present disclosure may be implemented.

It is described above that the present disclosure may be generally implemented by the computing device 100, but those skilled in the art will know well that the present disclosure may be implemented in association with a computer executable instruction which may be executed on one or more computers and/or in combination with other program modules and/or a combination of hardware and software.

Generally, program modules include routines, programs, components, data structures, and the like that perform particular tasks or implement particular abstract data types. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computer system, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

FIG. 7 illustrates an exemplary environment that implements various aspects of the present disclosure including a computer 1102 and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114(e.g., EIDE, SATA)—which may alternatively be configured for external use within a suitable chassis (not shown)—a magnetic floppy disk drive (FDD) 1116(e.g., for reading from or writing to a mobile diskette 1118), and an optical disk drive 1120(e.g., for reading from or writing to a CD-ROM disk 1122 or other high-capacity optical media such as a DVD). The computer 1102 may also include an external hard disk drive (HDD) 1114 connected via ports such as USB, Thunderbolt, or eSATA. The hard disk drive 1114, magnetic disk drive 1116, and optical disk drive 1120 can each be connected to the system bus 1108 via a hard disk drive interface 1124, a magnetic disk drive interface 1126, and an optical drive interface 1128, respectively. The interface 1124 for external drive implementations includes at least one of, or both, USB (Universal Serial Bus) and IEEE 1394 interface technologies.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication computing device on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example,at a data rate of 11 Mbps (802.11a) or 54 Mbps (802.11b) in unlicensed 2.4 and 5GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The description of the presented embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

What is claimed is:

1. A method for modifying operators by tracking a channel axis of an artificial intelligence model, performed by a computing device, comprising:
receiving a first artificial intelligence model executable in a first framework;
tracking, based on a forward-direction operation flow from a first reference operator to a second reference operator included in the first artificial intelligence model, a first forward candidate channel axis for each of intermediate tensors corresponding to a first intermediate operator present between the first reference operator and the second reference operator;
tracking, based on a backward-direction operation flow from the second reference operator to the first reference operator, a first backward candidate channel axis for each of the intermediate tensors corresponding to the first intermediate operator;
determining, based on the first forward candidate channel axis and the first backward candidate channel axis, a first channel axis for each of the intermediate tensors corresponding to the first intermediate operator; and
modifying, based on the determined first channel axis, at least some operators including the first intermediate operator within the first artificial intelligence model.

2. The method of claim 1,
wherein the position of the channel axis of input and output tensors corresponding to each of the first reference operator and the second reference operator is preset based on the first framework.

3. The method of claim 1,
wherein the intermediate tensors include:
an intermediate input tensor input to the first intermediate operator; and
an intermediate output tensor output from the first intermediate operator.

4. The method of claim 1,
wherein the determining the first channel axis comprises:
identifying, in the first intermediate operator, a first candidate channel axis that overlaps between the first forward candidate channel axis and the first backward candidate channel axis of each of the intermediate tensors; and
determining the overlapping first candidate channel axis as the first channel axis for each of the intermediate tensors corresponding to the first intermediate operator.

5. The method of claim 1,
wherein each of the first reference operator and the second reference operator is an operator in which the position of the channel axis of input and output tensors is identifiable without using another operator.

6. The method of claim 1,
wherein the tracking the first forward candidate channel axis comprises,
when an operation is performed in the first intermediate operator, if the first forward candidate channel axis of an intermediate input tensor is decomposed into a plurality of axes in an intermediate output tensor, determining each of the plurality of axes as the first forward candidate channel axis of the intermediate output tensor output from the first intermediate operator.

7. The method of claim 1,
wherein the tracking the first backward candidate channel axis comprises,
when an operation is performed in the first intermediate operator, if the first backward candidate channel axis of an intermediate output tensor is decomposed into a plurality of axes in an intermediate input tensor, determining each of the plurality of axes as the first backward candidate channel axis of the intermediate input tensor input to the first intermediate operator.

8. The method of claim 1,
wherein the modifying at least some operators comprises,
replacing a target operator combination corresponding to at least some operators with a mathematically interchangeable substitute operator combination.

9. The method of claim 8,
wherein in a case where a first intermediate output tensor is output from at least one first intermediate input tensor according to an operation flow of the target operator combination, the substitute operator combination includes a plurality of substitute operators having a connection relationship and properties set to output the first intermediate output tensor from the at least one first intermediate input tensor and to preserve channel information corresponding to the channel axis determined in the operation flow of the target operator combination.

10. The method of claim 8,
wherein the target operator combination includes:
a first linear transformation operator that performs a linear transformation-based operation; and
a first shape transformation operator that transforms a shape of an input tensor.

11. The method of claim 10,
wherein the substitute operator combination includes a second linear transformation operator mapped to be mathematically interchangeable with the first linear transformation operator, and the position of the channel axis included in each of the intermediate tensors of the first linear transformation operator and the position of the channel axis included in each of the intermediate tensors of the second linear transformation operator are different from each other, and the channel information corresponding to the first linear transformation operator is preserved in the second linear transformation operator.

12. The method of claim 11,
wherein the replacing the target operator combination with the substitute operator combination comprises,
by deleting at least one first shape transformation operator included in the target operator combination, transforming the shape of each of the intermediate tensors of the first linear transformation operator to the shape of each of the intermediate tensors of the second linear transformation operator, and aligning the position of the channel axis included in each of the intermediate tensors of the first linear transformation operator to the position of the channel axis included in each of the intermediate tensors of the second linear transformation operator.

13. The method of claim 11,
wherein the substitute operator combination includes at least one second shape transformation operator not included in the target operator combination, and the replacing the target operator combination with the substitute operator combination comprises, by adding the at least one second shape transformation operator to the target operator combination, transforming the shape of each of the intermediate tensors of the first linear transformation operator to the shape of each of the intermediate tensors of the second linear transformation operator, and aligning the position of the channel axis included in each of the intermediate tensors of the first linear transformation operator to the position of the channel axis included in each of the intermediate tensors of the second linear transformation operator.

14. The method of claim 10,
wherein the substitute operator combination has a smaller amount of computation than the target operator combination.

15. The method of claim 1,
wherein at least some operators correspond to an operation flow that is not supported by a target hardware or a target compiler, and are modified into an operation flow that is supported by the target hardware or the target compiler.

16. The method of claim 1, further comprising:
tracking, based on the forward-direction operation flow from a second reference operator to a third reference operator included in the first artificial intelligence model, a second forward candidate channel axis for each of the intermediate tensors corresponding to a second intermediate operator present between the second reference operator and the third reference operator;
tracking, based on the backward-direction operation flow from the third reference operator to the second reference operator, a second backward candidate channel axis for each of the intermediate tensors corresponding to the second intermediate operator;
determining, based on the second forward candidate channel axis and the second backward candidate channel axis, a second channel axis for each of the intermediate tensors corresponding to the second intermediate operator; and
modifying, based on the determined second channel axis, at least some operators including the second intermediate operator within the first artificial intelligence model.

17. The method of claim 1, further comprising:
pruning, based on the determined first channel axis, at least one channel of the intermediate input tensor or the intermediate output tensor corresponding to the first intermediate operator.

18. The method of claim 1,
wherein the modifying at least some operators comprises converting the first artificial intelligence model into a second artificial intelligence model executable in a second framework by replacing at least some operators with substitute operators executable in a second framework, based on the determined first channel axis, and the position of the channel axis included in each of the intermediate tensors of each of at least some operators is aligned to a preset position of the channel axis in the second framework for each of the substitute operators, and the channel information corresponding to the channel axis determined in the operation flow of at least some operators is preserved in the channel axis in the operation flow of the substitute operators.

19. A computing device for modifying operators by tracking a channel axis of an artificial intelligence model, comprising a processor including at least one core,
wherein the processor is configured to:
receive a first artificial intelligence model executable in a first framework;
track, based on a forward-direction operation flow from a first reference operator to a second reference operator included in the first artificial intelligence model, a first forward candidate channel axis for each of intermediate tensors corresponding to a first intermediate operator present between the first reference operator and the second reference operator;
track, based on a backward-direction operation flow from the second reference operator to the first reference operator, a first backward candidate channel axis for each of the intermediate tensors corresponding to the first intermediate operator;
determine, based on the first forward candidate channel axis and the first backward candidate channel axis, a first channel axis for each of the intermediate tensors corresponding to the first intermediate operator; and
modify, based on the determined first channel axis, at least some operators including the first intermediate operator within the first artificial intelligence model.

20. A non-transitory computer readable storage medium including a computer program, wherein the computer program causes a processor of a computer device to perform a method for modifying operators by tracking a channel axis of an artificial intelligence model, the method comprising:
receiving a first artificial intelligence model executable in a first framework;
tracking, based on a forward-direction operation flow from a first reference operator to a second reference operator included in the first artificial intelligence model, a first forward candidate channel axis for each of intermediate tensors corresponding to a first intermediate operator present between the first reference operator and the second reference operator;
tracking, based on a backward-direction operation flow from the second reference operator to the first reference operator, a first backward candidate channel axis for each of the intermediate tensors corresponding to the first intermediate operator;
determining, based on the first forward candidate channel axis and the first backward candidate channel axis, a first channel axis for each of the intermediate tensors corresponding to the first intermediate operator; and
modifying, based on the determined first channel axis, at least some operators including the first intermediate operator within the first artificial intelligence model.
